(19) United States
(12) Patent Application Publication
(10) Pub. No.: US 2002/0134280 A1
(43) Pub. Date: Sep. 26, 2002

(54) Ink composition

(76) Inventor: Hideaki Naruse, Kanagawa (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/054,956

(22) Filed: Jan. 25, 2002

(30) Foreign Application Priority Data
Jan. 25, 2001 (JP) P.2001-017019

(51) Int. Cl. C09D 11/00

(52) U.S. Cl. 106/31.27; 106/31.6; 106/31.58; 106/31.86

(57) ABSTRACT

An ink composition includes: an aqueous medium; a coloring compound dissolved or dispersed in the aqueous medium; and at least one clathrate compound, so as to exhibit excellent fastness and weather resistance.

### BACKGROUND OF THE INVENTION

1. Field of the Invention

The present invention relates to an ink composition and an ink composition for ink-jet recording, each excellent in fastness and weather resistance of images formed therewith.

2. Description of the Related Art

In recent years, with diffusion of computers, ink-jet printers have come to be used widely not only in offices but also at home for printing images on paper, film, cloth or the like. Particularly in full color ink-jet printers, an improvement in image quality proceeds rapidly, leading to an increase in the number of users who output, through these printers, images taken by a camera or the like.

At the same time, this also increases an opportunity of posting or storing images thus formed. There is accordingly a demand for overcoming fading due to light or discoloration or fading due to various gases (ozone, NOₓ or the like).

With a view to overcoming the above-described drawbacks, a variety of aqueous inks using a pigment or disperse dye have been proposed, for example, in JP-A-56-157468, JP-A-4-18468, JP-A-10-110126 and JP-A-10-195355. By these methods, water resistance is improved, but not completely. Particularly, pigment inks are accompanied with such drawbacks as inferiority in color development to dye inks and tendency to cause clogging at an orifice owing to poor storage stability of their dispersion.

As countermeasures against the above-described problems, disclosed are techniques of adding, to ink-jet recording paper, a benzophenone compound (JP-A-57-87988), a benzotriazole compound (JP-A-63-222885), a hindered amine compound (JP-A-61-146591) and a hydroquinone derivative (JP-2-238607). These techniques however did not succeed in formation of images having sufficient storage stability.

### SUMMARY OF THE INVENTION

An object of the present invention is to provide an ink composition and an ink-jet ink composition each excellent in fastness and weather resistance of images formed therewith.

The above-described object can be attained by the following items:

1. An ink composition comprising a coloring compound dissolved or dispersed in an aqueous medium, wherein the composition comprises at least one clathrate compound.

2. An ink composition as described above in item 1, wherein the clathrate compound is a calixarene derivative.

3. An ink composition as described above in item 1 or 2, wherein the coloring compound is a water soluble dye or oil soluble dye.

4. An ink-jet ink composition, which comprises an ink composition as described above in any one of items 1 to 3 as an ink-jet ink.

### DETAILED DESCRIPTION OF THE INVENTION

Embodiments of the present invention will hereinafter be described specifically.

An ink composition of the invention (which may hereinafter be called “ink composition of the invention”, simply) has a coloring compound such as water soluble dye or oil soluble dye dispersed in an aqueous medium and at the same time, contains at least one clathrate compound.

The ink composition of the invention is usable also as an ink-jet ink composition.

The action of the clathrate compound contained in the ink composition of the invention is to trap a portion or the whole portion of the water soluble or oil soluble dye molecules contained in the ink composition.

The term “clathrate compound” means—when one of two molecules, which have been combined under proper conditions, forms a tunnel-like, layered or net-like structure (which structure is called “clathrate lattice”) and the other molecule enters in the hole of the lattice—a compound forming this clathrate lattice (“Iwanami Physicochemical Dictionary, Fifth Edition, page 1296, published in 1988 by Iwanami Shoten”).

As the clathrate compound, usable are cyclodextrins (such as α-cyclodextrin, β-cyclodextrin and γ-cyclodextrin), crown compounds (such as 18-crown-6,15-crown-5, dibenzo-14-crown-4, dicyclohexyl-18-crown-6 and cryptand), cyclophanes, azacyclophanes, calixarenes (such as calix[4]arene, calix[6]arene and calix[8]arene), cyclotriberatolylene, spherands, cabitands, oligopeptides, deoxycholic acids, perhydrotriphenylenes, tri-O-thymotade and cyclophosphazene compounds.

Compounds described in “Basis and Application of Clathrate Compounds, by Fumio Tokuni, NTS, 1989” or “Design and Future Prospect of Functional Supermolecules, by Naoya Ogata, CMC, 1998”.

When a water soluble dye is used as a coloring compound, water soluble clathrate compounds such as cyclodextrin, calixarenes and deoxycholic acid are preferred.

Among the above-exemplified clathrate compounds, calixarenes represented by the below-described formula (I) are particularly preferred.

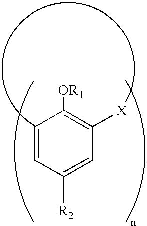

wherein:

R₁ represents a hydrogen atom or an alkyl, aryl, allyl, acetyl, alkyl ester or aryl ester group,

R₂ represents a hydrogen or halogen atom, or an alkyl (including cycloalkyl and bicycloalkyl), alkenyl (including cycloalkenyl and bicycloalkenyl), alkynyl, aryl, heterocyclic, hydroxyl, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino (including anilino), acylamino, aminocarbonylamino, alkoxycarbonylamino, aryloxycarbonylamino, sulfamoylamino, alkylsulfonylamino, arylsulfonylamino, mercapto, alkylthio, arylthio, heterocyclic thio, sulfanoyl, sulfo, alkylsulfinyl, arylsulfinyl, alkylsulfonyl, arylsulfonyl, acyl, aryloxycarbonyl, alkoxycarbonyl, carbamoyl, arylazo, heterocyclic azo, imido, phosphino, phosphinyl, phosphinyloxy, phosphinylamino, silyl, sulfonic acid or carboxylic acid group,

X each independently represents a divalent connecting group such as S, CH₂, SO₂ or SO, and

n stands for an integer of 4 to 12.

The followings are specific examples of calixarenes usable in the invention, but the present invention is not limited thereto.

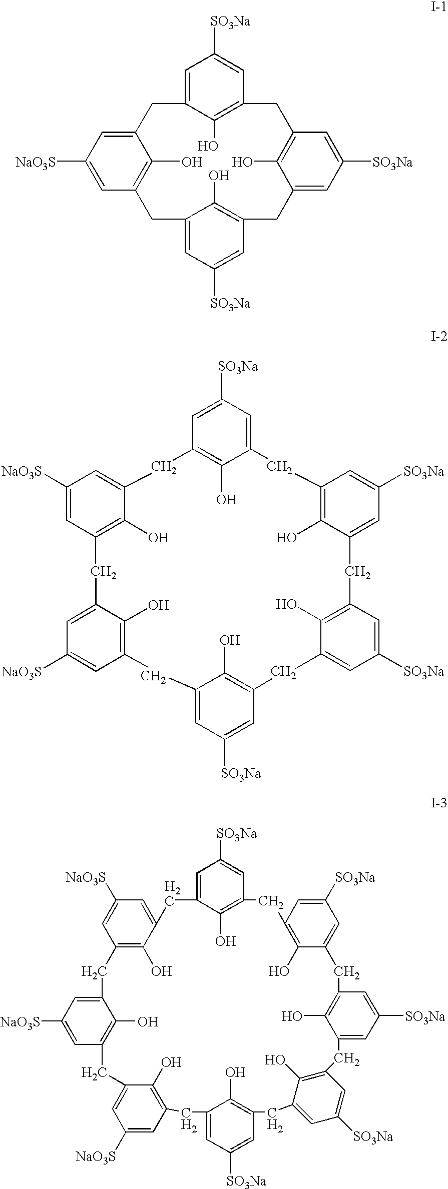

The above-exemplified clathrate compounds can be used in an amount of 10 to 1000 mole %, preferably 50 to 400 mole % relative to the coloring compound.

As the colorant to be used in the invention, water soluble dyes, oil soluble dyes and pigments are employed, of which water soluble dyes and oil soluble dyes are preferred.

The coloring compounds (the colorant) can be used in an amount of 0.05 to 30 weight %, preferably 0.1 to 20 weight %, more preferably 0.1 to 10 weight %, based on the ink composition.

A description will next be made of water soluble dyes and oil soluble dyes preferably employed as the coloring compound of the present invention.

As yellow dyes, any desired one can be employed. Examples include aryl or heterylazo dyes having, as a coupling component (which will hereinafter be called “coupler component”), a phenol, naphthol, aniline, heterocycle such as pyrazolone or pyridone, or open-chain type active methylene compound; azomethine dyes having an open-chain active methylene compound as a coupler component; methine dyes such as benzylidene and monomethineoxonol dyes; quinone dyes such as naphthoquinone and anthraquinone dyes; and other dyes such as quinophthalone, nitro-nitroso, acridine and acridinone dyes.

As magenta dyes, any desired one is usable in the invention. Examples include aryl or heterylazo dyes having a phenol, naphthol or aniline as a coupler component, azomethine dyes having a pyrazolone or pyrazolotriazole as a coupler component, methine dyes such as arylidene, styryl, merocyanine, cyanine and oxonol dyes, carbonium dyes such as diphenylmethane, triphenylmethane and xanthene dyes, quinone dyes such as naphthoquinone, anthraquinone and anthrapyridone dyes and condensed polycyclic dyes such as dioxazine dyes.

As cyan dyes, any desired one is usable in the invention. Examples include aryl or heterylazo dyes having a phenol, naphthol or aniline as a coupler component, azomethine dyes having, as a coupler component, a phenol, naphthol or heterocycle such as pyrrolotriazole, polymethine dyes such as cyanine, oxonol and merocyanine dyes, carbonium dyes such as diphenylmethane, triphenylmethane and xanthene dyes, phthalocyanine dyes, anthraquinone dyes and indigo-thioindigo dyes.

Each of the above-exemplified dyes may assume each of yellow, magenta and cyan colors for the first time after dissociation of a portion of its chromophore. In this case, a counter cation may be either an inorganic cation such as alkali metal or ammonium or an organic cation such as pyridinium or quaternary ammonium salt. Alternatively, it may be a polymer cation having, in its partial structure, such a cation.

Specific preferred examples include, not limited thereto, C.I. Solvent Black 3, 7, 27, 29 and 34, C.I. Solvent Yellow 14, 16, 19, 29, 30, 56, 82, 93 and 162, C.I. Solvent Red 1, 3, 8, 18, 24, 27, 43, 49, 51, 72, 72, 73, 109, 122, 132 and 218, C.I. Solvent Violet 3, C.I. Solvent Blue 2, 11, 25, 35, 38, 67 and 70, C.I. Solvent Green 3 and 7, and C.I. Solvent Orange 2. Of these, particularly preferred are Nubian Black PC-0850, Oil Black HBB, Oil Yellow 129, Oil Yellow 105, Oil Pink 312, Oil Red 5B, Oil Scarlet 308, Vali Fast Blue 2606, Oil Blue BOS (each, product of Orient Chemical Industries, Ltd.), Aizen Spilon Blue GNH (product of Hodogaya Chemical Co., Ltd.), Neopen Yellow 075, Neopen Mazenta SE1378, Neopen Blue 808, Neopen Blue FF4012 and Neopen Cyan FF4328 (each, product of BASF).

In the invention, disperse dyes are usable in an amount permitting their dissolution in a water non-miscible organic solvent. Preferred specific examples include C.I. Disperse Yellow 5, 42, 54, 64, 79, 82, 83, 93, 99, 100, 119, 122, 124, 126, 160, 184:1, 186, 198, 199, 201, 204, 224 and 237, C.I. Disperse Orange 13, 29, 31:1, 33, 49, 54, 55, 66, 73, 118, 119 and 163, C.I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33, C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368, and C.I. Disperse Green 6:1 and 9.

As particularly preferred oil soluble dyes, azo and azomethine dyes represented by the below-described formulas (1) and (2) can be mentioned. The dyes of the formula (2) are known as a dye formed from a coupler and a developing agent by oxidation in a photographic material.

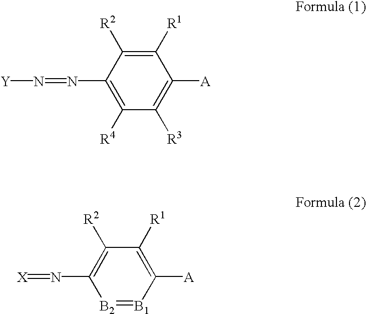

In the formulas (1) and (2),

R¹, R², R³ and R⁴ each independently represents a hydrogen or halogen atom, or an aliphatic, aromatic, heterocyclic, cyano, hydroxy, nitro, amino, alkylamino, alkoxy, aryloxy, amide, arylamino, ureido, sulfamoylamino, alkylthio, arylthio, alkoxycarbonylamino, sulfonamide, carbamoyl, sulfamoyl, sulfonyl, alkoxycarbonyl, heterocyclic oxy, azo, acyloxy, carbamoyloxy, silyloxy, aryloxycarbonyl, aryloxycarbonylamino, imide, heterocyclic thio, sulfinyl, phosphoryl, acyl, carboxyl or sulfo group.

A represents a —NR⁵R⁶ or hydroxy group, wherein R⁵ and R⁶ each independently represents a hydrogen atom or an aliphatic, aromatic or heterocyclic group. As A, —NR⁵R⁶ is preferred. R⁵ and R⁶ may be coupled to form a ring together with the nitrogen atom.

B₁ represents {C(R³)— or {N—, while B₂ represents —C(R⁴){ or —N{. Preferably, B₁ and B₂ do not represent —N{ at the same time, and more preferably, B₁ represents {C(R³)— and B₂ represents —C(R⁴){.

Each combination of R¹ and R⁵, R³ and R⁶, and R¹ and R² may be coupled to form an aromatic or heterocyclic ring.

X represents a residue of a color photographic coupler, and Y represents an unsaturated heterocyclic group.

It is preferred that R⁵ and R⁶ each independently represents a hydrogen atom, an aliphatic group, an aromatic group or a heterocyclic group, more preferably a hydrogen atom, an alkyl group, a substituted alkyl group, an aryl group or a substituted aryl group, most preferably a hydrogen atom, a C₁₋₁₈ alkyl group or a substituted C₁₋₁₈ alkyl group.

As R², preferred among the above-exemplified groups are hydrogen and halogen atoms, and aliphatic, alkoxy, aryloxy, amide, ureido, sulfamoylamino, alkoxycarbonylamino and sulfoneamide groups.

In this specification, the aliphatic group embraces alkyl, substituted alkyl, alkenyl, substituted alkenyl, alkynyl, substituted alkynyl, aralkyl and substituted aralkyl groups.

The aliphatic group may be branched or may contain a cyclic structure. The aliphatic group has preferably 1 to 20, more preferably 1 to 18 carbon atoms. The aryl portion of the aralkyl or substituted aralkyl group is preferably a phenyl or naphthyl group, with a phenyl group being particularly preferred.

Examples of the substituent at the alkyl portion of the substituted alkyl, substituted alkenyl, substituted alkynyl or substituted aralkyl group include groups as exemplified in R¹, R², R³ and R⁴.

The substituents at the aryl portion of the substituted aralkyl group are similar to those of the below-described substituted aryl group.

In this specification, aromatic groups embrace substituted aryl groups as well as aryl groups. Aryl groups are preferably phenyl and naphthyl groups, of which phenyl is particularly preferred.

The aryl portion of the substituted aryl groups is similar to the above-described aryl group.

Examples of the substituent of the substituted aryl groups include those exemplified in R¹, R², R³ and R⁴.

In this specification, the heterocyclic group preferably contains a 5- or 6-membered saturated or unsaturated heterocycle. The heterocycle may have, condensed therewith, an aliphatic ring, an aromatic ring or another heterocycle. Examples of the hetero atom of the heterocycle include N, O and S. Saturated heterocycles include pyrrolidine and morpholine rings, while unsaturated heterocycles include imidazole, thiazole, benzothiazole, benzooxazole, benzotriazole, pyridine and quinoline rings.

The heterocyclic group may have the group exemplified above in R¹ to R⁴.

In the formula (1), the unsaturated heterocyclic group represented by Y is preferably a 5- or 6-membered unsaturated heterocycle. The heterocycle may have, condensed therewith, an aliphatic ring, an aromatic ring or another heterocyclic ring. Examples of the hetero atom of the heterocycle include N, O and S. Unsaturated heterocycles include pyrazole, imidazole, thiazole, isothiazole, thiadiazole, thiophene, benzothiazole, benzoxazole, benzoisothiazole, pyrimidine, pyridine and quinoline rings.

The heterocyclic group may have the group exemplified above in R¹ to R⁴.

The coupler residue represented by X in the formula (2) is preferably the residue of the below-exemplified couplers.

Yellow couplers: U.S. Pat. Nos. 3,933,501, 4,022,620, 4,326,024, 4,401,752 and 4,248,961, JP-B-58-10739, British Patent Nos. 1,425,020 and 1,476,760, U.S. Pat. Nos. 3,973,968, 4,314,023 and 4,511,649, European Patent No. 249,473A, couplers represented by the formula (I) or (II) of European Patent No. 502,424A, couplers represented by the formula (1) or (2) of European Patent No. 513,496A (particularly, Y-28 on page 18), a coupler represented by the formula (I) of claim 1 of European Patent No. 568,037A, a coupler represented by the formula (I), lines 45 to 55, column 1 of U.S. Pat. No. 5,066,576, a coupler represented by the formula (I) in [0008] of JP-A-4-274425, a coupler described in claim 1 on page 40 of European Patent No. 498,381A1 (particularly, D-35 on page 18), a coupler represented by the formula (Y) on page 4 of European Patent No. 447,969A1 (particularly, Y1 (on page 17), Y-54 (page 41)) and couplers represented by the formulas (II) to (IV), lines 36 to 58, column 7 of U.S. Pat. No. 4,476,219 (particularly, II-17 and 19 (column 17), and II-24 (column 19)).

Magenta couplers: U.S. Pat. Nos. 4,310,619 and 4,351,897, European Patent No. 73,636, U.S. Pat. Nos. 3,061,432 and 3,725,067, Research Disclosure Nos. 24220 (June, 1984) and 24230 (June, 1984), JP-A-60-33552, JP-A-60-43659, JP-A-61-72238, JP-A-60-35730, JP-A-55-118034 and JP-A-60-185951, U.S. Pat. Nos. 4,500,630, 4,540,654 and 4,556,630, World IPO 088/04795, JP-A-3-39737 (L-57 (right bottom on page 11), L-68 (right bottom on page 12) and L-77 (right bottom on page 13)), European Patent Nos. 456,257 ([A-4]-63 (page 134), [A-4]-73, -75 (page 139)), 486,965 ([M-4, -6] (page 26), M-7 (page 27)) and 571,959A ([M-45] (page 19)), JP-A-S-2041006 ((M-1) (page 6)), JP-A-4-362631 (M-22 of [0237]), and U.S. Pat. Nos. 3,061,432 and 3,725,067.

Cyan couplers: U.S. Pat. Nos. 4,052,212, 4,146,396, 4,228,233 and 4,296,200, European Patent No. 73,636, JP-A-4-204843 (CX-1,3,4,5,11,12,13,15 (pages 14 to 16)), JP-A-4-43345 [C-7,10 (page 35), 34,35 (page 37), (I-1),(I-17) (pages 42 to 43)] and a coupler represented by the formula (Ia) or (Ib) of claim 1 of JP-A-6-67385.

Couplers as described in JP-A-62-215272 (page 91), JP-A-2-33144 (pages 3 and 30), EP 355,660A (pages 4, 5, 45 and 47) are also useful.

As the water soluble dye, azo dyes substituted with a water soluble group are preferably used in the invention, of which azo dyes having H acid or γ acid as a coupler portion and a heterocycle such as pyrazole or imidazole as a developing agent portion are more preferred.

The ink composition of the present invention can be prepared by dissolving and/or dispersing, in an aqueous medium, a coloring compound and a clathrate compound, and optionally another additive including surfactant.

The term “aqueous medium” as used herein means that obtained by adding, to water or a mixture of water and a small amount of a water miscible organic solvent, an additive such as humectant, stabilizer and antiseptic as needed.

When the additive is hydrophobic and it is dispersed in an aqueous medium, it is preferably dispersed in the form of fine particles by using a dispersing machine (such as ball mill, sand mill, attritor, roll mill, agitator mill, Henschel mixer, colloid mill, ultrasonic homogenizer, pearl mill, jet mill, Ang mill, Gaulin homogenizer, microfuidizer, altimizer, or emulsifying apparatus, such as “DeBEE 2000” of Bee International Ltd., using a ultrahigh pressure jet stream). Alternatively, the additives may be dissolved in a proper organic solvent, followed by emulsification and dispersion in an aqueous medium.

When a hydrophobic substance to be incorporated in the composition is emulsified and dispersed, a dispersant (emulsifier) or surfactant can be used. A high-boiling-point organic solvent can be used in combination. Examples include phthalate esters, phosphate or phosphonate esters, benzoate esters, amides, alcohols or phenols, aliphatic esters, aniline derivatives, chlorinated paraffins, trimesate esters, phenols, carboxylic acids and alkyl phosphoric acids. A water soluble polymer can be added to stabilize the dispersion.

As the water soluble polymer, polyvinyl alcohol, polyvinyl pyrrolidone, polyethylene oxide, polyacrylic acid and polyacrylamide and copolymers thereof are preferred. Natural water soluble polymers such as polysaccharides, casein and gelatin are also preferred. For stabilization of the dye dispersion, polyvinyl, polyurethane, polyester, polyamide, polyurea or polycarbonate available by polymerization of an acrylate ester, methacrylate ester, vinyl ester, acrylamide, methacrylamide, olefin, styrene, vinyl ether or acrylonitrile which is substantially insoluble in an aqueous medium can be used in combination. Such polymers preferably contain —SO₂— or —COO—. Upon combined use of such a polymer which is substantially insoluble in an aqueous medium, it is preferably used in an amount ranging from 10 to 1000 wt. % relative to the dye.

Preparation processes of an aqueous ink-jet ink composition are described specifically in JP-A-5-148436, JP-A-5-295312, JP-A-7-97541, JP-A-7-82515 and JP-A-7-118584 and they can be applied to the preparation of the ink composition of the present invention for ink-jet recording.

As the aqueous medium, a mixture composed mainly of water and containing, if desired, a water miscible organic solvent can be used. Examples of the water miscible organic solvent include alcohols (such as methanol, ethanol, propanol, isopropanol, butanol, isobutanol, sec-butanol, t-butanol, pentanol, hexanol, cyclohexanol and dibenzyl alcohol), polyhydric alcohols (such as ethylene glycol, diethylene glycol, triethylene glycol, polyethylene glycol, propylene glycol, dipropylene glycol, polypropylene glycol, butylene glycol, hexanediol, pentanediol, glycerin, hexane triol and thiodiglycol), glycol derivatives (such as ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethylether acetate, triethylene glycol monomethyl ether, triethylene glycol monoethyl ether and ethylene glycol monophenyl ether), amines (such as ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine and tetramethylpropylenediamine) and the other polar solvents (ex. formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile and acetone). These water miscible organic solvents can be used in combination.

In addition to the above-described compounds, an adequate amount of an additive selected from antidrying agent, penetration promoter, ultraviolet absorber, antioxidant, surface tension regulator, viscosity regulator, dispersant, dispersion stabilizer, antifungal agent, rust preventive, pH regulator, antifoaming agent and chelating agent can be added as needed to the ink composition of the present invention.

As the antidrying agent to be added to the ink composition of the invention, water soluble organic solvents having a vapor pressure lower than that of water are preferred. Specific examples include polyhydric alcohols typified by ethylene glycol, propylene glycol, diethylene glycol, polyethylene glycol, thiodiglycol, dithiodiglycol, 2-methyl-1,3-propanediol, 1,2,6-hexanetriol, acetylene glycol derivative, glycerin and trimethylolpropane; lower alkyl ethers of a polyvalent alcohol such as ethylene glycol monomethyl (or ethyl) ether, diethylene glycol monomethyl (or ethyl) ether and triethylene glycol monoethyl (or butyl) ether; heterocyclics such as 2-pyrrolidone, N-methyl-2-pyrrolidone, 1,3-dimethyl-2-imidazolidinone and N-ethylmorpholine; sulfur-containing compounds such as sulfolane, dimethylsulfoxide and 3-sulfolene; polyfunctional compounds such as diacetone alcohol and diethanolamine; and urea derivatives. Of these, polyhydric alcohols such as glycerin and diethylene glycol are more preferred. The above-exemplified antidrying agents may be used either singly or in combination. The antidrying agent is preferably added in an amount of 10 to 50 wt.% of the ink composition.

Examples of the penetration promoter usable in the invention include alcohols such as ethanol, isopropanol, butanol, diethylene glycol monobutyl ether, triethylene glycol monobutyl ether and 1,2-hexanediol and nonionic surfactants such as sodium lauryl sulfate and sodium oleate. Incorporation of it in an amount of 10 to 30 wt. % in the ink composition brings about sufficient effects. It is preferably added in an amount within a range not causing bleeding of print and print-through.

As the antioxidant to be used in the invention to improve storage stability of images, various organic or metal complex type antifading agents can be used. Organic antifading agents include hydroquinones, alkoxyphenols, dialkoxyphenols, phenols, anilines, amines, indanes, coumarones, alkoxyanilines and heterocycles, while metal complexes include nickel complexes and zinc complexes. More specifically, usable are compounds as described in “Research Disclosure”, No. 17643, VII, Section I or J. ibid No. 15162; ibid No. 18716, left column on page 650, ibid No. 36544, page 527, ibid No. 307105, page 872, and the patent cited in No. 15162; and those embraced in the formula of the typical compounds and compound examples described on pages 127 to 137 of JP-A-62-215272.

Examples of the antifungal agent usable in the ink composition of the invention include sodium dehydroacetate, sodium benzoate, sodium pyridinethion-1-oxide, ethyl p-hydroxybenzoate and 1,2-benzisothiazolin-3-one and salts thereof. It is preferably added in an amount of 0.02 to 5.00 wt. % of the ink composition.

Details of the antifungal agent are described in “Dictionary of Antibacterial and Antifungal Agents” (ed. by The Society for Antibacterial and Antifungal Agents, Japan).

Examples of the rust inhibitor include acidic lead sulfite, sodium thiosulfate, ammonium thioglycolate, diisopropylammonium nitrite, pentaerythritol tetranitrate, dicyclohexylammonium nitrite and benzotriazole. It is preferably added in an amount of 0.02 to 5.00 wt. % in the ink composition.

The pH regulator to be used in the ink composition of the invention functions well for regulating its pH and imparting it with dispersion stability. It is preferably added to adjust its pH to 4.5 to 10.0, more preferably to 6 to 10.0.

As basic pH regulators, organic bases and inorganic alkalis are usable while as acidic ones, organic acids and inorganic acids are usable.

The organic bases include triethanolamine, diethanolamine, N-methyldiethanolamine and dimethylethanolamine. The inorganic alkalis include hydroxides of an alkali metal (ex. sodium hydroxide, lithium hydroxide and potassium hydroxide), carbonates (ex. sodium carbonate and sodium bicarbonate) and ammonia.

The organic acids include acetic acid, propionic acid, trifluoroacetic acid and alkylsulfonic acid. The inorganic acids include hydrochloric acid, sulfuric acid and phosphoric acid.

The ink composition of the invention has preferably a surface tension of 20 to 50 mN/m or less at 25° C., with 20 to 40 mN/m or less being more preferred. When surface tension exceeds 50 mN/m, a marked deterioration in discharge stability occurs and at the same time, bleeding or projection occurs upon color mixing, thereby deteriorating print quality. At surface tension of the ink composition less than 20 mN/m, on the other hand, the ink happens to adhere to the hard surface upon discharging, thereby causing printing failure.

In order to regulate the surface tension, a cationic, anionic or nonionic surfactant can be added to the ink composition of the invention as a surface tension regulator. The surface tension regulator is preferably added in an amount of 0.01 to 20 wt. %, more preferably 0.1 to 10 wt. %, to the ink-jet ink composition. At least two of surfactants may be used in combination.

Since the ink composition of the invention has preferably a viscosity of 30 mPa.S or less, more preferably 20 mPa.S or less, a viscosity regulator is sometimes added in order to regulate its viscosity. The viscosity regulators include water soluble organic solvents having a high viscosity such as glycerin and water soluble polymers such as polyethylene glycol and polyvinyl alcohol. They are regulators for heightening the viscosity so that they are added in a small amount permitting it to fall within the above-described range.

It is also possible to add to the ink composition of the invention as needed the above-described cationic, anionic or nonionic surfactant as a dispersant or dispersion stabilizer, and a fluorine or silicon compound, or chelating agent typified by EDTA as an antifoaming agent.

In the next place, an ink-jet recording method using the ink-jet recording ink composition of the invention will be described. The ink composition of the invention can be used freely, if it is an ink-jet ink composition, without being limited by its recording method. It is used in a known recording process, for example, a charge control process of discharging ink by making use of electrostatic induction power, drop-on-demand process (pressure pulse process) making use of oscillation pressure of a piezoelectric element, acoustic ink-jet process of exposing ink to acoustic beams converted from electric signals and utilizing a radiation pressure for discharging ink, and thermal ink-jet process of heating ink to form bubbles and making use of the pressure thus generated.

Ink-jet recording processes include a process of jetting of a plurality of droplets of an ink having a low concentration called photoink, each droplet having a small volume, a process of improving image quality by using a plurality of inks having substantially the same hue but different concentrations and a process of using a colorless transparent ink.

The ink composition of the invention is discharged to various image receiving materials by the above-described process, whereby an image is formed. Examples of the image receiving materials include known materials to be recorded, more specifically, ordinary paper, resin-coated paper, such as paper exclusively used for ink-jet recording as described in JP-A-8-169172, JP-A-8-27693, JP-A-2-276670, JP-A-7-276789, JP-A-9-323475, JP-A-62-238783, JP-A-10-153989, JP-A-10-217473, JP-A-10-235995, JP-A-1O-337947, JP-A-10-217597 and JP-A-10-337947, film, electrophotographic paper, cloth, glass, metal and ceramic.

Recording paper and recording film desirable as an image receiving material to be used for ink-jet printing with the ink composition of the invention will next be described. As recording paper and recording film, those made by mixing, with a support made of chemical pulp such as LBKP or NBKP, mechanical pulp such as GP, PGW, RMP, TMP, CTMP, CMP or CGP, or recycled pulp such as DIP, conventionally known additives such as pigment, binder, sizing agent, fixer, cationic agent and paper strength agent as desired by using paper machine such as wire paper machine or cylinder paper machine. Alternatively, the support may be synthetic paper or plastic film sheet and it preferably has a thickness of 10 to 250 μm and a basis weight of 10 to 250 g/m².

The support may be used as a receiving material after disposing thereon an ink receptive layer and back coat layer, or after disposing a size press or anchor coat layer by using starch or polyvinyl alcohol and then disposing thereon an ink receptive layer and a back coat layer. The support may further be subjected to flattening treatment by a calendering machine such as machine calender, TG calender or soft calender. In the process of the invention, paper or a plastic film having both sides thereof laminated with polyolefin (ex. polyethylene, polystyrene, polyethylene terephthalate or polybutene, or copolymer thereof) is preferably employed as the support. Addition of a white pigment (ex. titanium oxide or zinc oxide) or a tinting dye (ex. cobalt blue, ultramarine or neodium oxide) to polyolefin is preferred.

In the ink receptive layer disposed on the support, a pigment and aqueous binder are incorporated. White pigments are preferred as the pigment. Examples of the white pigment include inorganic white pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide and zinc carbonate and organic pigments such as styrene pigments, acrylic pigments, urea resins and melamine resins. As the white pigment contained in the ink receptive layer, porous inorganic pigment, particularly, synthetic amorphous silica having a large pore area is preferred. As the synthetic amorphous silica, silicic anhydride available by dry process and hydrated silicic acid available by wet process are usable, of which hydrated silicic acid is desired.

An ink-jet recording method of forming an image by using a receiving material having, on a support thereof, an ink receptive layer containing white inorganic pigment particles is particularly suited for the ink composition of the invention.

Examples of the aqueous binder contained in the ink receptive layer include water-soluble polymers such as polyvinyl alcohol, silanol-modified polyvinyl alcohol, starch, cationated starch, casein, gelatin, carboxymethyl cellulose, hydroxyethyl cellulose, polyvinylpyrrolidone, polyalkylene oxide and polyalkylene oxide derivatives and water-dispersible polymers such as styrene butadiene latex and acrylic emulsion. These aqueous binders may be used either singly or in combination. Of them, polyvinyl alcohol and silanol-modified polyvinyl alcohol are particularly preferred for adhesion to the pigment and peel resistance of the ink receptive layer.

The ink receptive layer may contain, in addition to, the pigment and aqueous binder, a mordant, a water resistance improver, light resistance improver, surfactant, and the like additives.

The mordant to be added to the ink receptive layer is preferably immobilized. A polymeric mordant is preferably employed for this purpose.

Polymeric mordants are described in JP-A-48-28325, JP-A-54-74430, JP-A-54-124726, JP-A-55-22766, JP-A-55-142339, JP-A-60-23850, JP-A-60-23851, JP-A-60-23852, JP-A-60-23853, JP-A-60-57836, JP-A-60-60643, JP-A-60-118834, JP-A-60-122940, JP-A-60-122941, JP-A-60-122942, JP-A-60-235134 and JP-A-1-161236, and U.S. Pat. Nos. 2,484,430, 2,548,564, 3,148,061, 3,309,690, 4,115,124, 4,124,386, 4,193,800, 4,273,853, 4,282,305 and 4,450,224. Receiving materials containing the polymer mordant as described on pages 212 to 215 of JP-A-1-161236 are particularly preferred. Use of these polymer mordants makes it possible to form an image having excellent image quality and improved light resistance.

A water resistance improver is effective for improving water resistance of an image and as this agent, cationic resins are particularly desired. These cationic resins include polyamide polyamine epichlorohydrin, polyethyleneimine, polyaminesulfone, dimethyldiallyl ammonium chloride polymer, cation polyacrylamide and colloidal silica. Of these cationic resins, polyamide polyamine epichlorohydrin is particularly preferred. The cationic resin is preferably added in an amount of 1 to 15 wt. %, particularly 3 to 10 wt.% based on the whole solid content of the ink receptive layer.

Examples of the light resistance improver include zinc sulfate, zinc oxide, hindered amine antioxidants and benzotriazole ultraviolet absorbers such as benzophenone, of which zinc sulfate is particularly preferred.

The surfactant functions as a coating aid, peeling improver, slip improver or antistatic agent. Description on it can be found in JP-A-62-173463 and JP-A-62-183457.

Instead of the surfactant, organofluoro compound may be employed. The organofluoro compound is preferably hydrophobic. Examples of it include fluorine surfactants, oily fluorine compounds (ex. fluorine oil) and solid fluorine compound resins (ex. ethylene tetrafluoride resins). A description on the organofluoro compound can be found in JP-B-57-9053 (8-th to 17-th columns), and JP-A-61-20994 and JP-A-62-135826.

As the other additives to the ink receptive layer, pigment dispersants, thickeners, antifoaming agents, dyes, fluorescent brighteners, antiseptics, pH regulators, matting agents and hardeners can be used. The ink receptive layer may be a single layer or a double layer.

The recording paper or recording film may have a back coat layer disposed thereon. To this layer, white pigments, aqueous binders and the other components can be added. Examples of the white pigment to be incorporated in the back coat layer include white inorganic pigments such as light calcium carbonate, heavy calcium carbonate, kaolin, talc, calcium sulfate, barium sulfate, titanium dioxide, zinc oxide, zinc sulfide, zinc carbonate, titan white, aluminum silicate, diatomaceous earth, calcium silicate, magnesium silicate, synthetic amorphous silica, colloidal silica, colloidal alumina, pseudo boehmite, aluminum hydroxide, alumina, litopone, zeolite, hydrated halloysite, magnesium carbonate and magnesium hydroxide, and organic pigments such as styrene plastic pigment, acrylic plastic pigment, polyethylene, microcapsules, urea resins and melamine resins.

As the aqueous binder to be incorporated in the back coat layer, usable are water soluble polymers such as styrene/maleate salt copolymers, styrene/acrylate salt copolymers, polyvinyl alcohol, silanol-modified polyvinyl alcohol, starch, cationated starch, casein, gelatin, carboxymethyl cellulose, hydroxyethyl cellulose and polyvinylpyrrolidone, and water dispersible polymers such as styrene butadiene latex and acrylic emulsion. Examples of the other component to be incorporated in the back coat layer include antifoaming agent, foaming inhibitor, dye, fluorescent brightener, antiseptic and water resistance improver.

To layers (including back coat layer) constituting the ink-jet recording paper or recording film, a polymer latex may be added. It is used in order to improve the physical properties of a film, for example, stabilizing size and preventing curling, adhesion and cracks. A description on the polymer latex can be found in JP-A-62-245258, JP-A-62-1316648 and JP-A-62-110066. Addition of a polymer latex having a low glass transition point (40° C. or lower) to a mordant-containing layer enables to prevent occurrence of cracks or curing of the layer. Addition of a polymer latex having a high glass transition point also prevents occurrence of curling.

### EXAMPLES

The present invention will hereinafter be described in detail by Examples. It should however be noted that the present invention is not be limited to or by them.

### Example 1

(Preparation of Ink Set 101)

To the below-described components, deionized water was added to give the whole amount of 1 liter. While heating at 30 to 40° C., the mixture was stirred for one hour. The reaction mixture was then adjusted to pH 9 with 10 mol/l of KOH, followed by filtration, under reduced pressure, through a microfilter having a average pore size of 0.25 μm, whereby a light magenta ink solution was prepared.

| | | |
|---|---|---|
| Water soluble dye (T-1; magenta dye) | 3.75 | g |
| Diethylene glycol | 150 | g |
| Urea | 37 | g |
| Glycerin | 130 | g |
| Triethylene glycol monobutyl ether | 130 | g |
| Triethanolamine | 6.9 | g |
| Benzotriazole | 0.08 | g |
| PROXEL XL2 | 3.5 | g |

In a similar manner to the above-described method except that the kind of a dye and additives were changed, magenta ink, light cyan ink, cyan ink, yellow ink and black ink were prepared to form Ink Set 101.

TABLE 1

| | Light | | | | | |
|---|---|---|---|---|---|---|
| | Magenta | Magenta | Light cyan | Cyan | Yellow | Black |
| Coating | T-1 3/75 g/l | T-1 15.5 g/l | T-2 8.75 g/l | T-2 35.0 g/l | T-3 14.7 g/l | T-5 20.0 g/l |
| | | | | | T-4 14.0 g/l | T-6 20.0 g/l |
| | | | | | | T-7 20.0 g/l |
| | | | | | | T-3 21.0 g/l |
| Diethylene glycol | 150 g/l | 110 g/l | 130 g/l | 200 g/l | 160 g/l | 20 g/l |
| Urea | 37 g/l | 4.6 g/l | — | — | — | — |
| Glycerin | 130 g/l | 130 g/l | 150 g/l | 180 g/l | 150 g/l | 120 g/l |
| Triethylene glycol | 130 g/l | 140 g/l | 130 g/l | 140 g/l | 130 g/l | — |
| monobutyl ether | | | | | | |
| Diethylene glycol | — | — | — | — | — | 230 g/l |
| monobutyl ether | | | | | | |
| 2-Pyrrolidone | — | — | — | — | — | 80 g/l |
| Surfynol 465TG | 12.5 g/l | 11.5 g/l | 11.1 g/l | 9.8 g/l | 9.0 g/l | 8.5 g/l |
| Triethanolamine | 6.9 g/l | 7.4 g/l | 6.8 g/l | 6.7 g/l | 0.8 g/l | 17.9 g/l |
| Benzotriazole | 0.08 g/l | 0.07 g/l | 0.08 g/l | 0.08 g/l | 0.06 g/l | 0.06 g/l |
| Proxel XL2 | 3.5 g/l | 2.5 g/l | 1.8 g/l | 2.0 g/l | 2.5 g/l | 1.8 g/l |

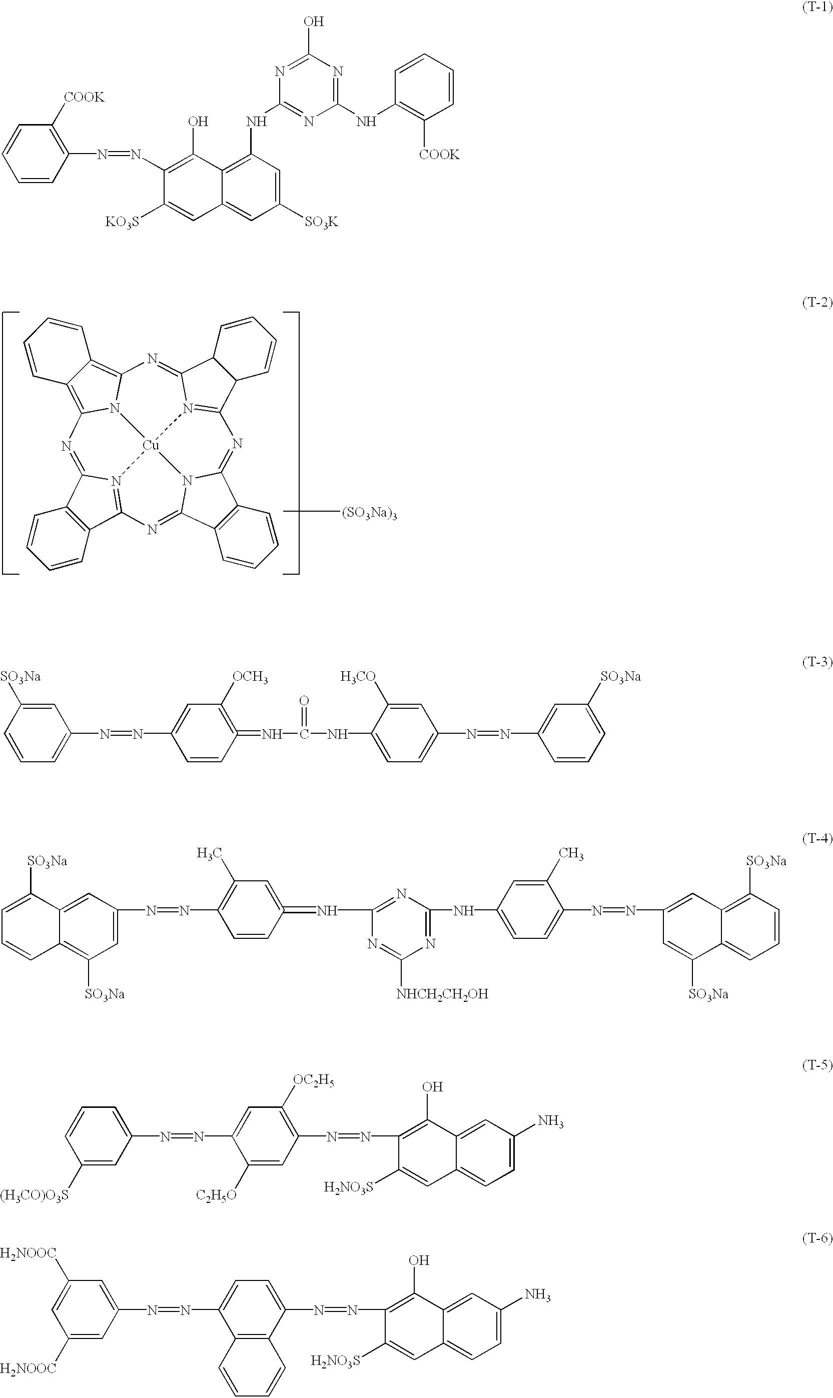

To Ink Set 101, a clathrate compound was added in an equimolar amount of the dye in accordance with Table 2, whereby Ink sets 102 to 113 were prepared.

Image fastness was determined by the following method.

1) Light fastness of image: After measuring a magenta reflection density by X-rite 310 rightly after printing, it was measured again after exposure to xenon light (85000 lux) for 7 days by using a weatherometer (product of Atlas). The percent residue of dye was calculated by the following equation:

(magenta density after exposure to xenon)/(magenta reflection density rightly after printing)*100

2) Fade resistance against ozone: After measuring magenta reflection density rightly after printing by X-rite 310, the print was allowed to stand at 25° C. for 7 days in the presence of 0.5 ppm ozone. The magenta reflection density was measured again and the percent residue of dye was calculated by the following equation:

(magenta reflection density after the print is allowed to stand in ozone)/(magenta reflection density rightly after printing)*100

TABLE 2

| Ink | Clathrate | Light | Ozone | |
|---|---|---|---|---|
| set | compound | fastness | resistance | Remarks |
| 101 | — | 60 | 49 | Comp. Ex. |
| 102 | I-1 | 88 | 90 | Invention |
| 103 | I-2 | 89 | 91 | Invention |
| 104 | I-3 | 91 | 93 | Invention |
| 105 | I-5 | 90 | 94 | Invention |
| 106 | I-6 | 90 | 92 | Invention |
| 107 | I-9 | 88 | 90 | Invention |
| 108 | α-Cyclodextrin | 72 | 68 | Invention |
| 109 | β-Cyclodextrin | 75 | 70 | Invention |
| 110 | γ-Cyclodextrin | 78 | 72 | Invention |
| 111 | 15-Crown-6-ether | 68 | 65 | Invention |
| 112 | 18-Crown 6-ether | 62 | 62 | Invention |
| 113 | Deoxycholic acid | 66 | 68 | Invention |

As is apparent from Table 2, addition of a clathrate compound according to the invention brings about a marked improvement in fastness against light and ozone. In particular, the above-described fastness is improved drastically when calixarenes represented by the formula (I) are used.

### Example 2

(Preparation of Ink 201)

In 6 g of a high-boiling-point organic solvent (S-1), 10 g of another high-boiling point organic solvent (S-2), 1.12 g of the below-described compound (U-1), 3.36 g of the described compound (U-2), 1.12 g of the below-described compound (U-3) and 50 ml of ethyl acetate, 8 g of an oil soluble dye (M-1) and 5 g of dioctylsulfosuccinic acid were dissolved at 70° C. To the resulting solution, 50 ml of deionized water was added while stirring by a magnetic stirrer, whereby an O/W type emulsion was prepared.

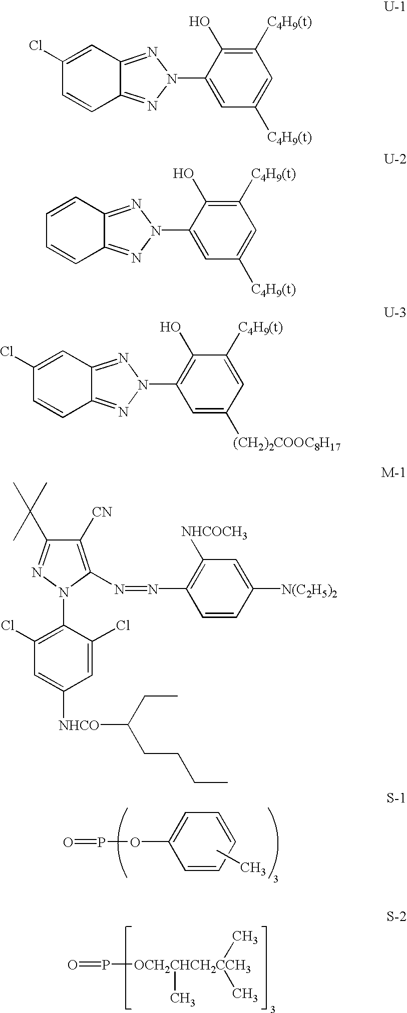

The emulsion was caused to pass through a high-pressure homogenizer (microfluoridizer manufactured by MICROFLUIDEX INC.) five times under pressure of 60 MPa to finely emulsify it. The resulting fine emulsion was subjected to low-boiling-point-solvent removing treatment by using a rotary evaporator until the odor of ethyl acetate disappeared.

After addition of 140 g of diethylene glycol, 64 g of glycerin, 7 g of a surfactant (“SURFYNOL 465”, product of Air Products & Chemicals), urea and additives as indicated in Table 1 to the fine emulsion thus obtained, 900 ml of deionized water was added. The resulting mixture was adjusted to pH 9 with a 10 mole/liter aqueous solution of potassium hydroxide, whereby a light magenta ink was prepared.

In accordance with Table 3, clathrate compounds were then added to the ink 201 in an equimolar amount of the dye, whereby inks 202 to 210 were prepared.

In a similar manner to Example 1, fastness was evaluated. Results are shown in Table 3.

TABLE 3

| Ink | Clathrate | Light | Ozone | |
|---|---|---|---|---|
| set | compound | fastness | resistance | Remarks |
| 201 | — | 40 | 22 | Comp. Ex. |
| 202 | I-4 | 78 | 70 | Invention |
| 203 | I-7 | 79 | 69 | Invention |
| 204 | I-10 | 81 | 68 | Invention |
| 205 | I-11 | 80 | 67 | Invention |
| 206 | I-2 | 80 | 65 | Invention |
| 207 | Calix-8-arene | 80 | 70 | Invention |
| 208 | Dibenzo-14- | 62 | 48 | Invention |
| | crown-4-ether | | | |
| 209 | γ-Cyclodextrin | 65 | 47 | Invention |
| 210 | Cyclophane | 68 | 42 | Invention |

As is apparent from Table 3, addition of clathrate compounds according to the invention brings about a marked improvement in fastness against light and ozone. In particular, this improvement is drastic when calixarenes represented by the formula (I) and calix-8-arene were added.

### Example 3

Inks similar to those prepared in Examples 1 and 2 were filled in the cartridge of “Inkjet Printer BJ-F850 Canon Inc.). By this printer, an image was printed on “Inkjet Paper Glossy Photo paper EX” of Fuji Photo Film Co., Ltd. Evaluation was conducted as in Example 1, whereby similar results to Example 1 were obtained. Similar effects were observed when image receiving paper was photo paper “PM” of Seiko Epson Corp. or “PR101” of Canon Inc.

As described above, the present invention makes it possible to provide an ink-jet recording ink composition excellent in fastness and weather resistance of images formed therewith.

This application is based on Japanese patent application JP 2001-017019, filed Jan. 25, 2001, the entire content of which is hereby incorporated by reference, the same as if set forth at length.

What is claimed is:

1. An ink composition comprising: an aqueous medium;
a coloring compound dissolved or dispersed in the aqueous medium; and at least one clathrate compound.

2. The ink composition of claim 1, wherein the clathrate compound is a calixarene derivative.

3. The ink composition of claim 1, wherein the clathrate compound is represented by formula (I): 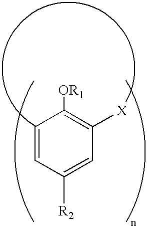
Wherein R₁ represents a hydrogen atom or an alkyl, aryl, allyl, acetyl, alkyl ester or aryl ester group; R₂ represents a hydrogen or halogen atom, or an alkyl (including cycloalkyl and bicycloalkyl), alkenyl (including cycloalkenyl and bicycloalkenyl), alkynyl, aryl, heterocyclic, hydroxyl, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino (including anilino), acylamino, aminocarbonylamino, alkoxycarbonylamino, aryloxycarbonylamino, sulfamoylamino, alkylsulfonylamino, arylsulfonylamino, mercapto, alkylthio, arylthio, heterocyclic thio, sulfamoyl, sulfo, alkylsulfinyl, arylsulfinyl, alkylsulfonyl, arylsulfonyl, acyl, aryloxycarbonyl, alkoxycarbonyl, carbamoyl, arylazo, heterocyclic azo, imido, phosphino, phosphinyl, phosphinyloxy, phosphinylamino, silyl, sulfonic acid or carboxylic acid group; X each independently represents a divalent connecting group such as S, CH₂, SO₂ or SO; and n stands for an integer of 4 to 12.

4. The ink composition of claim 1, wherein the coloring compound is a water soluble dye or oil soluble dye.

5. The ink composition of claim 2, wherein the coloring compound is a water soluble dye or oil soluble dye.

6. The ink composition of claim 1, which is used as an ink-jet ink.

7. The ink composition of claim 2, which is used as an ink-jet ink.

8. The ink composition of claim 3, which is used as an ink-jet ink.

9. The ink composition of claim 4, which is used as an ink-jet ink.

10. The ink composition of claim 5, which is used as an ink-jet ink.

11. The ink composition of claim 1, wherein the at least one clathrate compound is used in an amount of 10 to 1000 mol % based on the coloring compound.

12. The ink composition of claim 1, wherein the at least one clathrate compound is at least one of cyclodextrins, crown compounds, cyclophanes, azacyclophanes, calixarenes, cyclotriberatolylene, spherands, cabitands, oligopeptides, deoxycholic acids, perhydrotriphenylenes, tri-O-thymotade and cyclophosphazene compounds.

13. The ink composition of claim 1, wherein the coloring compound is used in an amount of 0.05 to 30 weight % based on the ink composition.
